(19) United States
(12) Patent Application Publication
(10) Pub. No.: US 2021/0221402 A1
(43) Pub. Date: Jul. 22, 2021

(54) PREDICTION CONTROL DEVICE

(71) Applicant: Hitachi Automotive Systems, Ltd., Hitachinaka-shi, Ibaraki (JP)

(72) Inventors: Toshiaki NAKAMURA, Tokyo (JP); Teppei HIROTSU, Tokyo (JP); Hideyuki SAKAMOTO, Hitachinaka (JP)

(73) Assignee: Hitachi Automotive Systems, Ltd., Hitachinaka-shi, Ibaraki (JP)

(21) Appl. No.: 17/255,748

(22) PCT Filed: Jun. 5, 2019
(86) PCT No.: PCT/JP2019/022267

§ 371 Date: Dec. 23, 2020

(30) Foreign Application Priority Data
Jul. 2, 2018 (JP) 2018-126250

(51) Int. Cl. B60W 60/00; G06K 9/00

(52) U.S. Cl. CPC B60W 60/0015; B60W 2554/4044; B60W 2554/4049; G06K 9/00791

(57) ABSTRACT

A prediction control device is realized which can respond to changes in the surrounding situations while the own vehicle is traveling and can perform a rapid operation during normal driving and in an emergency as if a person drives. The prediction control device includes a means (103, 104) for detecting a change amount and a change direction of surroundings and the own vehicle, and a means 105 for setting an initial value and a prediction period of a solution search calculation in a prediction control means based on the detection result. The means 105 for setting the initial value and the prediction period has a fail operational control mode in which the initial value and the prediction period set according to the change amount of the surroundings and the own vehicle is set with a previous calculation result of the solution search calculation to the initial value.

### TECHNICAL FIELD

The present invention relates to a prediction control device applied to automatic driving of a vehicle.

### BACKGROUND ART

In recent years, automatic driving of vehicles has been on the way of practical use, and in this case, the application of model prediction control is expanding for the generation of tracks for automatic driving.

As a prediction control technique for automatic driving of a vehicle, a technique as described in PTL 1 is disclosed.

As a prediction control device and a recommended operation presentation device that can reduce the amount of calculation and improve the responsiveness, PTL 1 discloses a technique in which a change in the time constant of the controlled object is observed, at least one of settings of a sampling time, a prediction section, and a control section is changed according to a change amount, and the control is stabilized according to a control target.

### CITATION LIST

### Patent Literature

PTL 1: JP 2006-72747 A

### SUMMARY OF INVENTION

### Technical Problem

In PTL 1, the processing speed is increased by mainly observing the time constant change and the target control amount of the controlled object and adjusting the control parameters of the prediction control, but the surrounding situation changes from moment to moment during the automatic driving of the vehicle.

Therefore, it is necessary to observe not only the situation of the own vehicle to be controlled but also the change of the surrounding situation during traveling, and to increase the speed accordingly.

However, the technique described in PTL 1 does not take into consideration changes in the surrounding situations while the vehicle is traveling, and does not perform control corresponding to the surrounding situations while the own vehicle is traveling.

From the above, an object of the invention is to realize a prediction control device capable of rapid operation in response to changes in surrounding situations while the vehicle is traveling.

### Solution to Problem

In order to achieve the above object, the invention is configured as follows.

A prediction control device includes a means for detecting a change amount and a change direction of surroundings and the own vehicle, and a means for setting an initial value and a prediction period of a solution search calculation in a prediction control means based on the detection result.

### Advantageous Effects of Invention

According to the invention, it is possible to realize a prediction control device which can respond to changes in the surrounding situations while the own vehicle is traveling and can perform a rapid operation during normal driving and in an emergency as if a person drives.

### BRIEF DESCRIPTION OF DRAWINGS

FIG. 1 is a diagram illustrating a block configuration example of an automatic driving control system for a vehicle, which is a prediction control device according to a first embodiment of the invention.

FIG. 2 is a diagram illustrating a block configuration example of an operation command value generation unit in a model prediction control unit.

FIG. 3 is a diagram illustrating a block configuration example of an output prediction unit in the model prediction control unit.

FIG. 4 is a diagram illustrating a block configuration example of an evaluation function calculation unit in the model prediction control unit.

FIG. 5 is a diagram illustrating a block configuration example of a situation recognition unit.

FIG. 6 is a diagram illustrating a block configuration example of a change amount detection unit.

FIG. 7A is a diagram for explaining a method of determining an initial value for a weight Wa of a control condition adjustment unit.

FIG. 7B is a diagram for explaining a method of determining a prediction period for a weight Wb of the control condition adjustment unit.

FIG. 8 is a diagram illustrating a block configuration example of the control condition adjustment unit.

FIG. 9 is a diagram illustrating another block configuration example of the control condition adjustment unit.

FIG. 10 is a diagram illustrating a block configuration example of an initial value setting unit.

FIG. 11A is a diagram illustrating the number of times of calculation until the evaluation function output of prediction control converges when the invention is not used.

FIG. 11B is a diagram illustrating the number of times of calculation until the evaluation function output of prediction control converges when the previous optimum solution is included in the initial value candidates in the first embodiment of the invention.

FIG. 11C is a diagram illustrating the number of times of calculation until the evaluation function output of the prediction control converges when the prediction period is shortened in the first embodiment of the invention.

FIG. 12 is a diagram illustrating a track of automatic driving of a vehicle by prediction control in the first embodiment of the invention.

### DESCRIPTION OF EMBODIMENTS

Hereinafter, embodiments of the invention will be described using the drawings.

### EMBODIMENTS

### First Embodiment

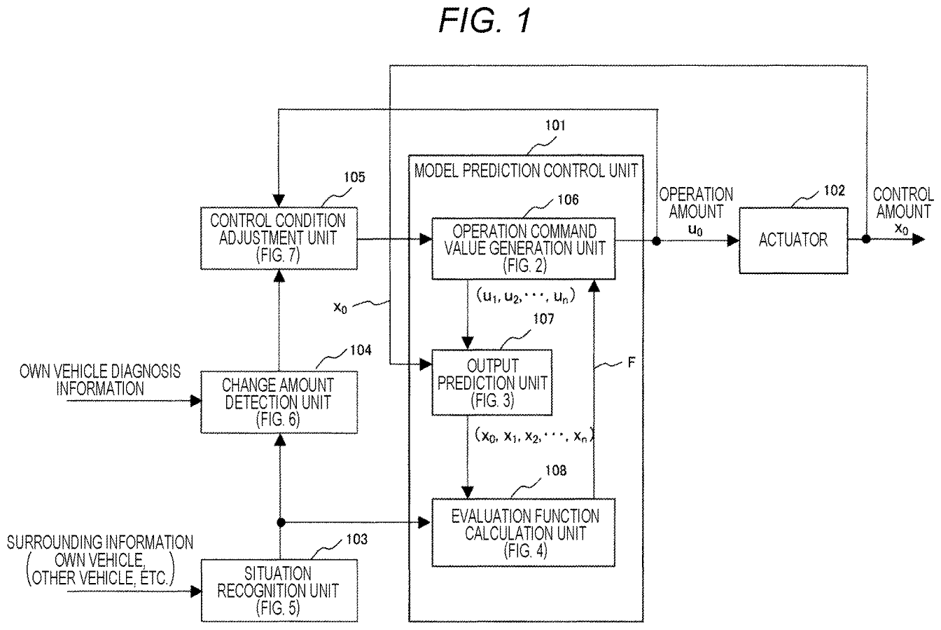

FIG. 1 is a diagram illustrating a block configuration example of an automatic driving control system for a vehicle, which is a prediction control device according to a first embodiment of the invention.

In FIG. 1, a model prediction control unit 101 (prediction control means) performs a process (solution search calculation) of obtaining an operation amount after several milliseconds while predicting the speed and the advancing direction of the own vehicle for several seconds in the future, for example, every few milliseconds based on the information around the own vehicle. A part of the input of the model prediction control unit 101 is ambient information, and a part of the output is an operation amount u₀ for an actuator 102 such as steering wheel operation, accelerator operation, and brake operation.

The model prediction control unit 101 includes an operation command value generation unit 106, an output prediction unit 107, and an evaluation function calculation unit 108.

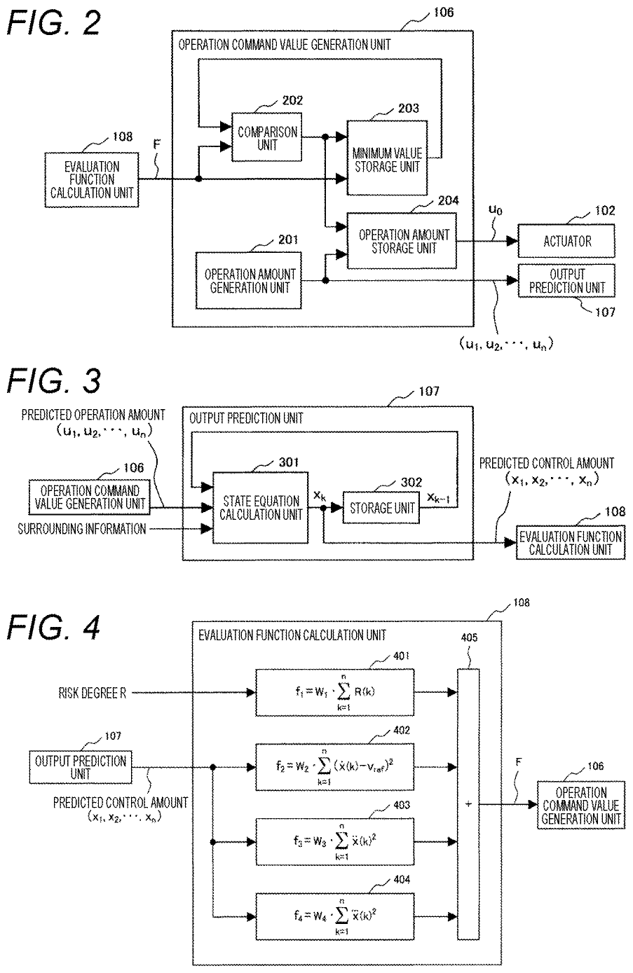

Of these, the operation command value generation unit 106 is a means that generates, for example, the current operation amount u₀ and operation amount candidates (u₁ to uₙ) as predicted values for n seconds in the future at every few milliseconds from the next operation amount u₁ for the actuator 102. The operation command value generation unit 106 will be described later with reference to FIG. 2.

For example, the output prediction unit 107 is a means that inputs, for example, the operation amount candidates (u₁ to uₙ) and the current control amount x₀ of the own vehicle output from the actuator 102 to the state equation expressing the operation model of a vehicle by a mathematical formula, and outputs the control amounts (speed, position, direction, etc.) corresponding to this as control amount candidates (x₁ to xₙ) which are predicted the values corresponding to the outputs of the actuator 102. The output prediction unit 107 will be described later with reference to FIG. 3.

The evaluation function calculation unit 108 is a means that expresses a constraint condition required for the automatic driving with a plurality of functions, receives the control amount candidate (x₁ to xₙ) from the output prediction unit 107, and outputs a sum F of the outputs of the functions for the constraint condition to the operation command value generation unit 106. The evaluation function calculation unit 108 will be described later with reference to FIG. 4.

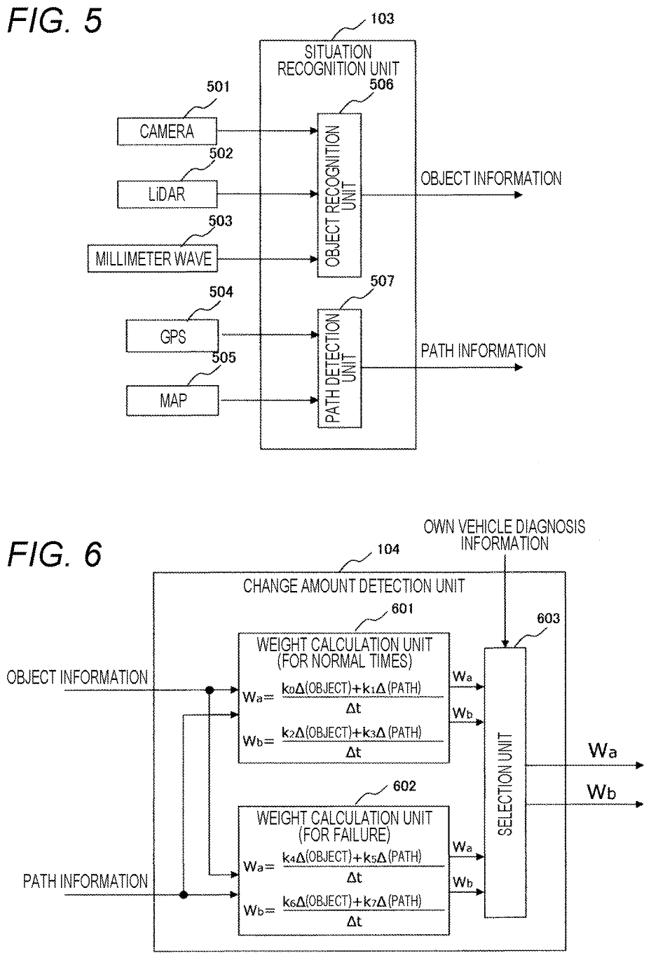

A situation recognition unit 103 is a means that recognizes a moving object (dynamic obstacle) such as other vehicles, bicycles, and pedestrians on a traveling road, a stationary object (stationary obstacle) such as guardrails and a stopped vehicle, path information up to the destination of the own vehicle, and the position of the own vehicle from the information of the surrounding situation of the traveling own vehicle, and outputs. The situation recognition unit 103 will be described later with reference to FIG. 5.

Regarding the recognized object and traveling path of the own vehicle, a change amount detection unit 104 is a means for detecting a change amount of a relative position per unit time with respect to the own vehicle (a change amount and a change direction of the surroundings and the own vehicle obtained from the relative position and the relative speed with respect to the dynamic obstacle and the stationary obstacle) as weighting coefficients, and outputs the coefficients to a control condition adjustment unit 105. The change amount detection unit 104 will be described later with reference to FIG. 6.

The situation recognition unit 103 and the change amount detection unit 104 form a means for detecting the change amount and the change direction in the surroundings and the own vehicle.

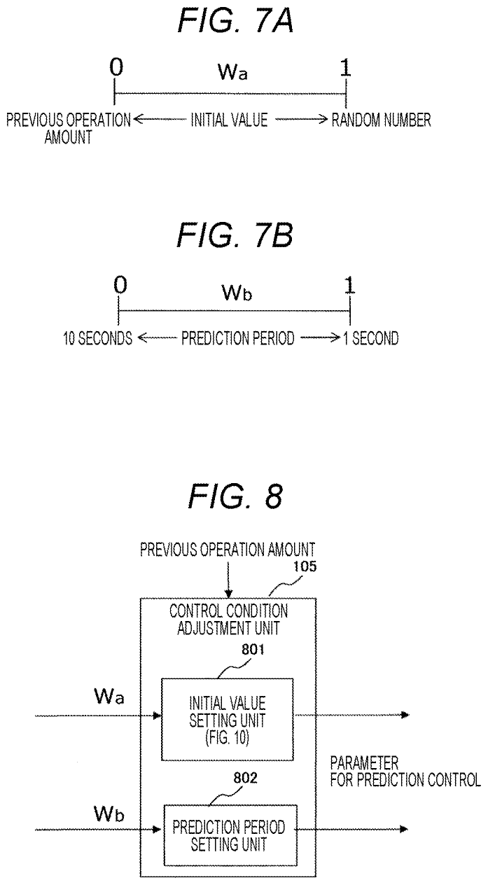

The control condition adjustment unit 105 is a means for adjusting and setting an initial value and a prediction period for performing a model prediction control calculation based on the weighting coefficient input from the change amount detection unit 104. That is, it is a means for setting the initial value and the prediction period of the optimum value search calculation (solution search calculation) performed by the operation command value generation unit 106 and outputting them to the operation command value generation unit 106. The control condition adjustment unit 105 will be described later with reference to FIG. 7.

In the model prediction control unit 101 having the above configuration, the loop processing from the operation command value generation unit 106 to the output prediction unit 107 and the evaluation function calculation unit 108 is repeated a plurality of times in a few milliseconds, for example. The operation command value 106 selects the operation amount candidates (u₁ to uₙ) having the minimum sum F of the evaluation functions. Then, the operation amount u₁ at the next time point is output to the actuator 102. The actuator 102 converts the operation amount u into the control amount x and executes the brake, accelerator, steering wheel operation, and the like.

Hereinafter, the detailed configuration of each part of the prediction control device illustrated in FIG. 1 will be described.

FIG. 2 is a diagram illustrating a block configuration example of the operation command value generation unit 106 in the model prediction control unit 101. In FIG. 2, the operation command value generation unit 106 receives an evaluation function F output from the evaluation function calculation unit 108, and generates and outputs the operation amount u₀ and the operation amount candidates (u₁ to uₙ) for the actuator 102 accordingly.

A comparison unit 202 in the operation command value generation unit 106 compares the calculation result (output of the evaluation function F) output from the evaluation function calculation unit 108 with the value stored in a minimum value storage unit 203. If the value input from the evaluation function calculation unit 108 to the comparison unit 202 is smaller than the value stored in the minimum value storage unit 203, a store command signal is output to the minimum value storage unit 203. The minimum value storage unit 203 stores the calculation result of the evaluation function in response to the store command signal from the comparison unit 202. The series of processing up to this point means that the value that minimizes the output F of the evaluation function operation 108 has been obtained.

An operation amount generation unit 201 is a means for generating the operation amount candidates (u₁ to uₙ) from the operation amount candidate u₁ at the next time point to the operation amount candidate uₙ at n time point in the future. As an example of the operation amount candidate, the operation amount candidate value is generated by generating a random number as an initial value, and then a convergent solution is obtained by repeating the operation of changing the value little by little.

Specific methods include particle swarm optimization, ant colony optimization, and artificial bee colony algorithm.

An operation amount storage unit 204 stores the operation command value candidates (u₁ to uₙ) corresponding to the evaluation function values stored in the minimum value storage unit 203, and outputs the current operation amount u₀ to the actuator 102 such as the brake, the accelerator, and the steering angle of the front wheel. Further, the operation amount candidates (u₁ to uₙ) are output to the output prediction unit 107 illustrated in FIG. 3.

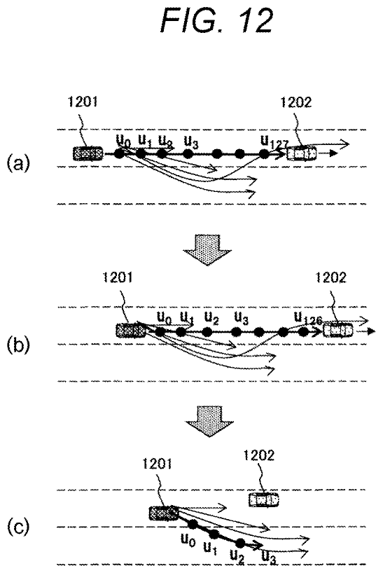

The current operation amount u₀ can be calculated using, for example, the next operation amount candidate u₁ obtained in the previous processing cycle. According to the operation command value generation unit 106 of FIG. 2, it is possible to obtain operation amount candidates (u₁ to uₙ), which are time-series operation amounts that minimize the evaluation function F. This means that the track illustrated by the solid line in FIG. 12, which will be described later, has been obtained.

FIG. 3 is a diagram illustrating a block configuration example of the output prediction unit 107 in the model prediction control unit 101. In FIG. 3, a state equation calculation unit 301 is a means for expressing the operation model of the vehicle by a mathematical formula. For example, when an acceleration or an angle in the advancing direction is input, the state equation calculation unit 301 converts the physical amount such as the position coordinates, speed, and azimuth angle of the own vehicle. A storage unit 302 is a means for temporarily storing the output of the state equation calculation unit 301 and using it for the next prediction processing. For example, the predicted value of the next position coordinates can be calculated by saving the current position coordinates and speed.

In the example of FIG. 3, the state equation calculation unit 301 receives a time-series predicted operation amount (u₁ to uₙ) from the operation command value generation unit 106 in order to express the operation model of the vehicle by a mathematical formula. Further, the control amount corresponding to the output of the actuator 102 is calculated as a time-series prediction control amount (x₁ to xₙ), output to the evaluation function calculation unit 108, and used for the calculation of the evaluation function. In FIG. 3, the storage unit 302 is used to determine a reference position, but as illustrated in FIG. 1, this may be determined based on the current position indicated by the actuator 102.

FIG. 4 is a diagram illustrating a block configuration example of the evaluation function calculation unit 108 in the model prediction control unit 101. In FIG. 4, in the evaluation function calculation unit 108, a plurality of constraint condition function units (a risk degree calculation unit 401, a speed error calculation unit 402, an acceleration calculation unit 403, an acceleration increasing rate calculation unit 404) expressing the constraint condition required for the automatic driving by a function are used to generate the value of the evaluation function F output to the operation command value generation unit 106.

In the example of FIG. 4, a risk degree R output from the situation recognition unit 103 and the constraint condition function unit for the time-series prediction control amount (x₀ to xₙ) obtained by the output prediction unit 107 are provided.

The evaluation function calculation unit 108 is configured by a plurality of constraint condition function calculation units (401 to 404). In the invention, the evaluation function F is defined by the plurality of constraint condition function units (401 to 404).

The plurality of constraint condition functions include a function f1 for the degree of risk of the own vehicle obtained by the risk degree calculation unit 401, a function f2 for the speed error obtained by the speed error calculation unit 402, a function f3 for the acceleration obtained by the acceleration calculation unit 403, and a function f4 about the acceleration increasing rate obtained by the acceleration increasing rate calculation unit 404. The evaluation function F is a function configured by five elements including a function f5 for responsiveness obtained by the output prediction unit 107. Minimum numerical values determined by these five elements are obtained.

Hereinafter, each of the plurality of constraint condition function calculation units (401 to 404) will be described.

First, the risk degree calculation unit 401 obtains the risk degree R (k), for example, from the situation recognition unit 103, at each time point from the next time point (k=1) to n time point (k=n) in the future from the ambient information and the relative position information of the own vehicle, calculates a multiplication result of the risk degree R (k) and a weighting coefficient W₁, and calculates the constraint condition function f1 with respect to the risk degree in which the sum of these values is obtained.

The speed error calculation unit 402 integrates the acceleration information of the own vehicle to obtain the speed, calculates a multiplication result of the square of the difference between the speed and a target speed V_{ref} from the next time point (k=1) to n time point (k=n) in the future and a weighting coefficient W₂, and calculates the constraint condition function f2 with respect to the speed in which the sum of these values are obtained.

Based on the acceleration information of the own vehicle, the acceleration calculation unit 403 calculates a multiplication result of the square of the acceleration from the next time point (k=1) to n time point (k=n) in the future and a weighting coefficient W₃, and calculates the constraint condition function f3 with respect to the acceleration in which the sum of these values are obtained.

Based on the acceleration information of the own vehicle, the acceleration increasing rate calculation 404 differentiates the acceleration information of the own vehicle to obtain an acceleration increasing rate, calculates a multiplication result of the square of the acceleration increasing rate from the next time point (k=1) to n time point (k=n) in the future and a weighting coefficient W₄, and calculates the constraint condition function f4 with respect to the acceleration increasing rate in which the sum of these values are obtained. An addition unit 405 adds the output results of the constraint condition functions obtained by the constraint condition function calculation units (401 to 404) to each other, and outputs the output results to the operation command value generation unit 106.

The evaluation function calculation unit 108 is configured as described above, but as described above, the prediction control device controls the vehicle by the operation amount u when the output of the evaluation function F is minimized. However, the four constraint condition functions that determine the output of the evaluation function F, the constraint condition function f1 of the risk degree, the constraint condition function f2 of the speed error, the constraint condition function f3 of the acceleration, and the constraint condition function f4 of the acceleration increasing rate reflect the operating condition at that time.

FIG. 5 is a diagram illustrating a block configuration example of the situation recognition unit 103. In FIG. 5, a camera 501 captures the surrounding situations of the front, rear, left, and right sides of the own vehicle. A LiDAR 502 uses a laser beam to detect the surrounding situation of the own vehicle. A millimeter-wave radar 503 detects the surrounding situations by the reflected light of radio waves.

A GPS 504 detects the longitude and latitude where the own vehicle is located. A map 505 outputs path information from the departure point of the own vehicle to the planned arrival point. An object recognition unit 506 recognizes an object such as another vehicle, a bicycle, or a pedestrian based on the data input from the camera 501, the LiDAR 502, and the millimeter-wave radar 503, and outputs the object information. In addition, an own vehicle path detection unit 507 detects the current position on the map of the own vehicle based on the input information from the GPS 504 and the map 505, and outputs the map information around the local point on the path.

FIG. 6 is a diagram illustrating a block configuration example of the change amount detection unit 104. In FIG. 6, a weight calculation unit 601 for normal times sets the value obtained by multiplying the change amount on the time axis of the object information and the path information input from the situation recognition unit 103 by the coefficients k₀ and k₁, respectively, as the weight Wa, and outputs the value obtained by multiplying k₂ and k₃ is output as the weight Wb. Similarly, a weight calculation unit 602 for failure sets the value obtained by multiplying the change amount on the time axis of the object information and the path information input from the situation recognition unit 103 by the coefficients k₄ and k₅, respectively, as the weight Wa, and outputs the value obtained by multiplying k₆ and k₇ is output as the weight Wb. When it is determined as normal from diagnosis information of the own vehicle input from the ECU or the like mounted on the own vehicle, a selection unit 603 selects the output of the weight calculation unit 601 for normal times. When information (a failure notification signal from each actuator) indicating a failure is input, the selection unit 603 selects the output of the weight calculation unit 602 for failure and outputs the selected output. Therefore, the change amount of the own vehicle includes the traveling path of the own vehicle and the signal input of the failure notification from each actuator belonging to the own vehicle.

FIG. 7A is a diagram for explaining a method of determining an initial value for the weight Wa by the control condition adjustment unit 105. In FIG. 7A, the weight Wa takes a value in the range of 0 to 1, and if Wa=0, for example, the value obtained in the previous solution search calculation is used as a candidate for the initial value. Further, if Wa=1, the ratio of random numbers is increased as the weight Wa increases, so that the candidate of the initial value is determined by the generation of random numbers.

FIG. 7B is a diagram for explaining a method of determining the prediction period for the weight Wb by the control condition adjustment unit 105. In FIG. 7B, the weight Wb takes a value in the range of 0 to 1, and if Wb=0, for example, the prediction period is 10 seconds, and if Wb=1, the prediction period is shortened as the weight Wb increases so that the weight Wb becomes 1 second.

FIG. 8 is a diagram illustrating a block configuration example of the control condition adjustment unit 105. In FIG. 8, the initial value setting unit 801 determines the candidate value of the initial value for the optimum value search calculation which is output to the operation command value generation unit 106 according to the value of the weight Wa input from the change amount detection unit 104. A prediction period setting unit 802 determines (adjusts) the prediction period for performing the optimum value search calculation which is output to the operation command value generation unit 106 according to the value of the weight Wb input from the change amount detection unit 104.

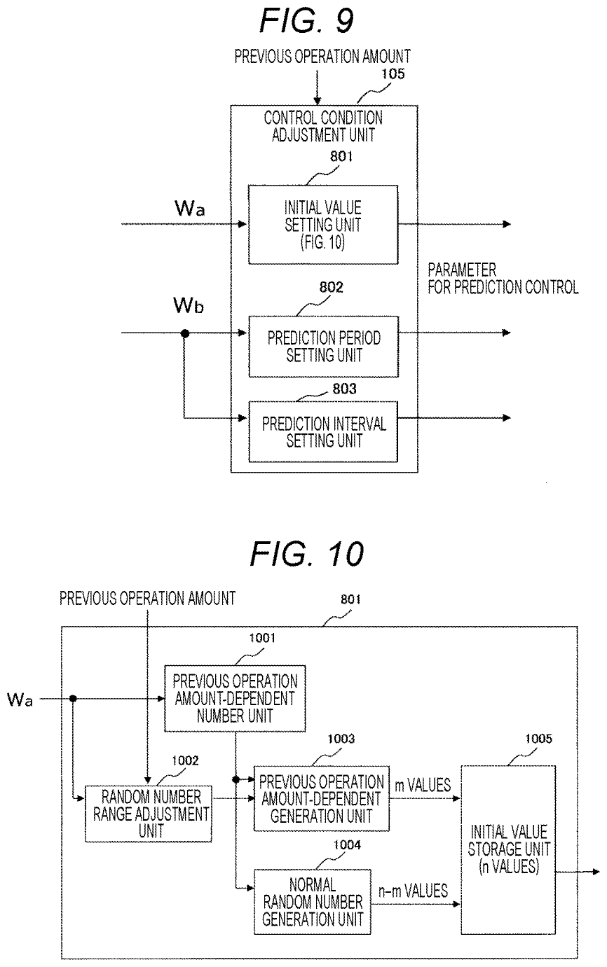

FIG. 9 is a diagram illustrating a block configuration example different from the configuration illustrated in FIG. 8 of the control condition adjustment unit 105, and is an example of adjusting a prediction interval in addition to the initial value and the prediction period of the prediction control. In FIG. 9, the initial value setting unit 801 and the prediction period setting unit 802 have the same functions as the block configuration example of FIG. 8. A prediction interval setting unit 803 determines the prediction interval by the optimum value search calculation which is output to the operation command value generation unit 106 according to the value of the weight Wb to be input. For example, if Wb=0, the operation amount candidates (u₁ to uₙ) are obtained at 0.1 second intervals in the prediction period of 10 seconds. If Wb=1, the operation amount candidates (u₁ to uₙ) are obtained at 0.01 second intervals in the prediction period of 1 second. As a result, the amount of calculation required for the prediction control is constant regardless of the value of Wb, and the prediction interval of each operation amount candidate (u₁ to uₙ) can be narrowed.

The control condition adjustment unit 105 is an example of the means for setting the initial value and the prediction period of the solution search calculation in the model prediction control unit 101 (prediction control means) based on the detection results of the means (103 and 104) for detecting the change amount and the change direction of the surroundings and the own vehicle.

FIG. 10 is a diagram illustrating a block configuration example of the initial value setting unit 801 illustrated in FIGS. 8 and 9. In FIG. 10, a previous operation amount-dependent number unit 1001 determines which ratio of the plurality of initial values to be prepared is the initial value depending on the previous operation amount, according to the value of the weight Wa. For example, when the operation amount candidates (u₁ to uₙ) are one set, and 100 sets are prepared as the initial value thereof, if Wa=1, all 100 sets are prepared as the initial values to which a change based on the previously adopted operation amounts (u₁ to uₙ) is added. In addition, when Wa=0.5, 50 sets are prepared as the initial values to which a change based on the previously adopted operation amounts (u₁ to uₙ) is added. When Wa=0, it is determined that the surrounding situation changes greatly and there is no dependence on the previous operation amount, and the initial values of all 100 sets are generated by random numbers. A random number range adjustment unit 1002 determines the range of random numbers to be added to each value based on the operation amount adopted last time.

The random number range adjustment unit 1002 determines that the closer the value of Wa is to 1, the higher the dependence on the operation amount adopted last time, and narrows the range of values that the random number can take.

A previous operation amount-dependent generation unit 1003 generates an initial value by adding the random number generated by the random number range adjustment unit 1002 to the previous operation amount.

A normal random number generation unit 1004 generates a random number within a preset range and generates an initial value.

An initial value storage unit 1005 stores the initial values generated by the previous operation amount-dependent generation unit 1003 and the normal random number generation unit 1004. Each stored number is the ratio of the number determined by the previous operation amount-dependent number unit 1001. For example, when 100 sets of initial values are stored, and Wa=0.3, 30 sets of initial values generated by the previous operation amount-dependent generation unit 1003 are stored, and 70 sets of initial values generated by the normal random number generation unit 1004 are stored.

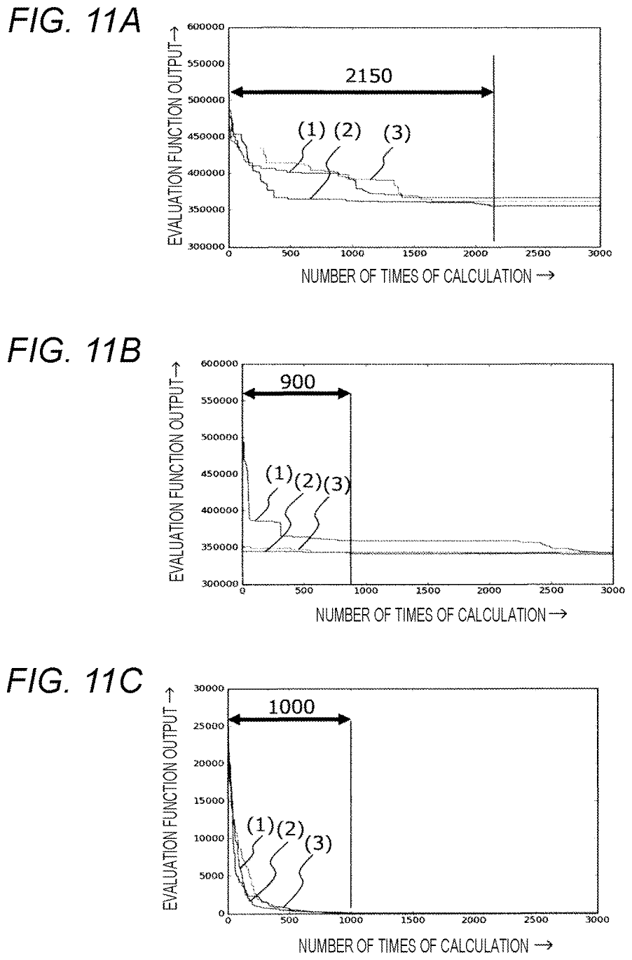

FIG. 11A is a graph illustrating the characteristics of the evaluation function output value with respect to the number of times of calculation when the invention is not used. In FIG. 11A, the vertical axis represents the evaluation function output, the horizontal axis indicates the number of times of calculation, and (1), (2), and (3) indicate the first, second, and third calculations, respectively. The number of times of calculation until the minimum value is converged is different in each time, and the number of times of calculation that can be determined to have converged to the minimum value in all three times is set to 2150 times.

FIG. 11B is a graph illustrating the characteristics when the previous optimum solution is included in the initial value in the first embodiment of the invention. In FIG. 11B, as in FIG. 11A, the vertical axis represents the evaluation function output and the horizontal axis represents the number of times of calculation. Since the first calculation (1) uses all the values generated by random numbers as the initial values, it takes 3000 calculations to converge to the minimum value. On the other hand, in the second calculation (2) and the third calculation (3), since the previous optimum solution is included in the initial value, convergence to the minimum value is completed in 900 calculations.

FIG. 11C is a graph illustrating the characteristics when the prediction period in the invention is shortened from 128 time points to 16 point times. In FIG. 11C, as in FIG. 11A, the vertical axis represents the evaluation function output and the horizontal axis represents the number of times of calculation. The initial values are all generated with random numbers as in FIG. 11B, but since the prediction period is as short as 16 time points compared to 128 time points in FIG. 11B, the number of times of calculation until convergence occurs all three times is only 1000 times.

FIG. 12 is a diagram illustrating an operation example of automatic driving by model prediction control. In FIG. 12, it is assumed that a vehicle 1201 in the traveling lane of a highway in automatic driving travels behind a vehicle 1202 traveling in the same traveling lane. In FIG. 12, the traveling lane is illustrated by a broken line.

(a) of FIG. 12 is a diagram in which the own vehicle 1201 is traveling behind the other vehicle 1202 on the highway. At this time, in order to drive efficiently, the own vehicle 1201 selects a time-series control amount u₀ to uₙ (indicated by a thick solid line; u₀ to u₁₂₇ in the example of (a) of FIG. 12) from among a plurality of candidates of control amounts x (indicated by a plurality of solid lines), and determines u₁ as the control amount at the next time point.

(b) of FIG. 12 is an example in which the prediction control calculation is performed by including the previously selected track in the initial value. In the example illustrated in (b) of FIG. 12, there is almost no change in the surrounding situations of the own vehicle 1201 in (a) of FIG. 12, so the predicted track selected is also the same as the example illustrated in (a) of FIG. 12. In this case, since sudden changes in speed and direction are suppressed, there is an effect that the automatic driving is comfortable for the occupants. Further, in FIG. 6, when the own vehicle diagnosis information input to the selection unit 603 is a signal indicating “failure”, the same track as the previous time is maintained, which contributes to rapid fail operational control (fail operational control contribution mode).

(c) of FIG. 12 is a diagram illustrating a predicted track obtained by shortening the prediction period. In the example illustrated in (c) of FIG. 12, the other vehicle 1202 stops due to the road shoulder compared to the example illustrated in (b) of FIG. 12, so the change amount over time is large and the weight Wb becomes a value close to 1, and the prediction period Is shortened to obtain the predicted track this time. In this case, since the time until the optimum track is obtained is shortened, it is possible to respond to sudden changes in the surrounding situations. In addition, in FIG. 6, when the own vehicle diagnosis information is “1”, the prediction period can be shortened and a track to be retracted to the road shoulder can be immediately generated, which contributes to rapid fail-safe control (fail-safe control contribution mode).

According to the first embodiment of the invention illustrated above, the change amount of the surrounding situation of the own vehicle is detected, and the initial value and the prediction period of the prediction control are changed according to the detected change amount. Therefore, it is possible to realize a prediction control device capable of achieving both a ride comfort during normal driving and a rapid operation in an emergency as if a person drives.

Further, according to the first embodiment, the control is switched to perform the prediction control by including the previously selected track in the initial value according to the magnitude of the change amount in the own vehicle and the surrounding situation of the own vehicle, or the prediction control by shortening the prediction period to generate a random number. Therefore, the vehicle operation can be appropriately controlled according to the change in the surrounding situations of the own vehicle.

### Second Embodiment

Next, a second embodiment of the invention will be described.

In the first embodiment, the mode that contributes to the fail operational control and the mode that contributes to the rapid fail-safe control are switched.

The second embodiment is common to the first embodiment in that the initial value and the prediction period of the prediction control are changed according to the surrounding situations of the own vehicle and the change of the own vehicle, but does not have the fail-safe control contribution mode. That is, in the second embodiment, the control condition adjustment unit 105 that sets the initial value and the prediction period has only the fail operational control mode in which the initial value and the prediction period, which are set according to the surrounding situations of the own vehicle and the change amount of the own vehicle, are set as the operation amounts by including the previous calculation result (operation amount) of the solution search calculation.

In the second embodiment, the riding comfort during normal driving can be achieved even when a vehicle breakdown or the like occurs.

The difference in configuration between the second embodiment and the first embodiment is that in the second embodiment, the initial value setting unit 801 and the prediction period setting unit 802 of the control condition adjustment unit 105 illustrated in FIGS. 8 and 9 use the previous operation amount in the fail operational control mode.

Since the other configurations of the second embodiment are the same as those of the first embodiment, illustration and detailed description thereof will be omitted.

According to the second embodiment, it is possible to realize a prediction control device having an improved ride comfort during normal driving.

Further, in the second embodiment, since the fail-safe control mode is not provided as compared with the first embodiment, the calculation load thereof can be reduced. For example, even when a failure of the own vehicle occurs while driving on a highway, the track can be maintained quickly.

### REFERENCE SIGNS LIST

101 model prediction control unit
102 actuator
103 situation recognition unit
104 change amount detection unit
105 control condition adjustment unit
106 operation command value generation unit
107 output prediction unit
108 evaluation function calculation unit
201 operation amount generation unit
202 comparison unit
203 minimum value storage unit
204 operation amount storage unit
301 state equation calculation unit
302 storage unit
401 risk degree calculation unit
402 speed error calculation unit
403 acceleration calculation unit
404 acceleration increasing rate calculation unit
405 addition unit
501 camera
502 LiDAR
503 millimeter-wave radar
504 GPS
505 map information unit
506 object recognition unit
507 own vehicle path detection unit
601 weight calculation unit for normal times
602 weight calculation unit for failure
603 selection unit
801 initial value setting unit
802 prediction period setting unit
803 prediction interval setting unit
1001 previous operation amount-dependent number unit
1002 random number range adjustment unit
1003 previous operation amount-dependent generation unit
1004 normal random number generation unit
1005 initial value storage unit
1201 own vehicle
1202 other vehicle

1. A prediction control device, comprising:
a means for detecting a change amount and a change direction of surroundings and an own vehicle; and
a means for setting an initial value and a prediction period of a solution search calculation in a prediction control means based on the detection result.

2. The prediction control device according to claim 1,
wherein the means for setting the initial value and the prediction period has a fail operational control mode in which the initial value and the prediction period set according to the change amount of the surroundings and the own vehicle is set with a previous calculation result of the solution search calculation to the initial value.

3. The prediction control device according to claim 2,
wherein the change amount and the change direction of the surroundings are obtained from a relative position and a relative speed of a dynamic obstacle and a stationary obstacle with respect to the own vehicle.

4. The prediction control device according to claim 2,
wherein the change amount of the own vehicle includes a signal input of a failure notification from a traveling path of the own vehicle and an actuator of each part to which the own vehicle belongs.

5. The prediction control device according to claim 1,
wherein the prediction control device is a prediction control device that determines an operation amount to be applied to an actuator of a vehicle for automatic driving of the vehicle,
wherein the prediction control means includes
an operation command value generation unit that generates an operation amount for the actuator and an operation amount candidate as a predicted value, an output prediction unit that outputs a control amount candidate as a predicted value corresponding to an output of the actuator using a state equation expressing an operation model of a vehicle by a mathematical formula, and an evaluation function calculation unit that expresses a constraint condition required for an automatic driving of a vehicle with a plurality of functions and obtains a sum of outputs of the functions for the constraint condition,
wherein the means for detecting the change amount and the change direction of the surroundings and the own vehicle includes
a situation recognition unit that recognizes an object on a traveling road and a path of the own vehicle from a surrounding situation of the traveling own vehicle, and a change amount detection unit that detects an amount of temporal change of the recognized object and path, and
wherein the operation command value generation unit generates an operation amount for the actuator according to an output from the evaluation function calculation unit, and the means for setting the initial value and the prediction period of the solution search calculation adjusts an initial value and a prediction period to be set to the operation command value generation unit according to situations of traveling surroundings and the own vehicle.

6. The prediction control device according to claim 5,
wherein the change amount detection unit obtains the amount of temporal change of the recognized object or the traveling path of the own vehicle from a change amount of a relative position per unit time with respect to the own vehicle.

7. The prediction control device according to claim 5,
wherein the change amount detection unit outputs a value obtained by multiplying a coefficient by the amount of temporal change obtained from the recognized object and traveling path of the own vehicle as a weighting coefficient.

8. The prediction control device according to claim 5,
wherein the change amount detection unit outputs the weighting coefficient as a different value according to a diagnosis result of the own vehicle.

9. The prediction control device according to claim 5,
wherein the control condition adjustment unit adjusts an initial value, a prediction period, and a prediction interval of prediction control.

10. The prediction control device according to claim 9,
wherein the control condition adjustment unit adjusts the initial value, the prediction period, and the prediction interval according to the weighting coefficient input from the change amount detection unit.

11. The prediction control device according to claim 10,
wherein the control condition generation unit includes an initial value setting unit that sets the initial value, and
wherein the initial value setting unit includes a previous operation amount-dependent number unit that sets a previous operation amount-dependent number, a random number range adjustment unit that adjusts a range of a random number to be generated, a previous operation amount-dependent number unit that generates an initial value dependent to a previous operation amount, a normal random number generation unit that generates an initial value from a random number, and an initial value storage unit that stores a plurality of the generated initial values.

12. The prediction control device according to claim 1,
wherein the means for setting the initial value and the prediction period of the solution search calculation switches between a fail operational control mode in which the initial value and the prediction period set according to the change amount of the surroundings and the own vehicle is set with a previous calculation result of the solution search calculation to the initial value and a fail-safe control mode in which the prediction period is shortened and set.

13. The prediction control device according to claim 12,
wherein the change amount of the own vehicle includes a signal input of a failure notification from a traveling path of the own vehicle and an actuator of each part to which the own vehicle belongs.

14. The prediction control device according to claim 12,
wherein the prediction control device is a prediction control device that determines an operation amount to be applied to an actuator of a vehicle for automatic driving of the vehicle,
wherein the prediction control means includes
an operation command value generation unit that generates an operation amount for the actuator and an operation amount candidate as a predicted value, an output prediction unit that outputs a control amount candidate as a predicted value corresponding to an output of the actuator using a state equation expressing an operation model of a vehicle by a mathematical formula, and an evaluation function calculation unit that expresses a constraint condition required for an automatic driving of a vehicle with a plurality of functions and obtains a sum of outputs of the functions for the constraint condition,
wherein the means for detecting the change amount and the change direction of the surroundings and the own vehicle includes
a situation recognition unit that recognizes an object on a traveling road and a path of the own vehicle from a surrounding situation of the traveling own vehicle, and a change amount detection unit that detects an amount of temporal change of the recognized object and path, and
wherein the operation command value generation unit generates an operation amount for the actuator according to an output from the evaluation function calculation unit, and the means for setting the initial value and the prediction period of the solution search calculation adjusts an initial value and a prediction period to be set to the operation command value generation unit according to situations of traveling surroundings and the own vehicle.

15. The prediction control device according to claim 5,
wherein the evaluation function calculation unit includes
a risk degree calculation unit that obtains a function for a risk degree of the own vehicle based on a risk degree output from the situation recognition unit,
a speed error calculation unit that obtains a function for speed error based on the control amount candidate from the output prediction unit,
an acceleration calculation unit that obtains a function for acceleration based on the control amount candidate from the output prediction unit,
an acceleration increasing rate calculation unit that obtains a function for an acceleration increasing rate based on the control amount candidate from the output prediction unit, and
an addition unit that adds functions obtained by the risk degree calculation unit, the speed error calculation unit, the acceleration calculation unit, and the acceleration increasing rate calculation unit to each other to output the added value to the operation command value generation unit.
